(19) United States
(12) Patent Application Publication
(10) Pub. No.: US 2019/0263621 A1
(43) Pub. Date: Aug. 29, 2019

(54) CORE FOR WINDING YARN, METHOD OF WINDING YARN, BOBBIN, AND METHOD OF CUTTING CORE

(71) Applicant: BEAR PAPER TUBE, LLC, Dalton, GA (US)

(72) Inventors: Michael Wise, Dalton, GA (US); Chad Anderson, Rocky Face, GA (US)

(73) Assignee: BEAR PAPER TUBE, LLC

(21) Appl. No.: 15/903,317

(22) Filed: Feb. 23, 2018

(51) Int. Cl. B65H 35/00; B65H 75/10; B32B 1/08; B65H 54/34; B65H 65/00

(52) U.S. Cl. CPC B65H 35/008; B65H 75/10; B65H 2701/31; B65H 54/34; B65H 65/00; B32B 1/08

(57) ABSTRACT

A core for winding yarn can include an oblong hollow body and a laser-cut structure disposed through a portion of a wall of the hollow body adjacent to an end of the hollow body. A method of cutting a core for winding yarn can include providing a core comprising an oblong hollow body, and irradiating a wall of the hollow body with a laser beam to form a laser-cut structure. A method of winding yarn can include placing a core on a winding mandrel, placing a tail of a length of yarn through a laser-cut structure of the core, and spinning the core to wind the length of yarn around the core. A bobbin can include yarn wound around a core including a laser-cut structure.

### FIELD

The present disclosure is generally in the field of textiles. In various non-exclusive embodiments, the disclosure is directed to a core for winding yarn, a method of winding yarn, a bobbin including a core, and a method of cutting a core.

### BACKGROUND

Yarn is commonly used to make textile products such as carpet, clothing, towels, blankets, rope, etc. Yarn can include natural fibers, synthetic fibers, or blends of thereof. Yarn can be wound onto to a core for storage and transport, as well as dispensing the yarn for textile manufacturing processes.

Yarn can be wound onto a core using a high-speed winder. High-speed winding of yarn can apply stress to a core and cause the core to disintegrate. If a core disintegrates during a winding process, the winding is typically stopped to remove remains of the damaged core. Stopping winding due to a damaged core can result in a reduction in manufacturing efficiency.

Some manufacturers prefer to use paper cores rather than plastic and metal cores, because a paper core may be less likely to generate dangerous fragments if the core disintegrates during high-speed winding. Paper cores are generally constructed of a lamination of sheets of paper with an adhesive to hold the sheets together. The lamination can provide the core with the rigidity required for winding, shipping, and storing yarn.

### SUMMARY

Cutting a paper core with a punch and die can create defects in the core and increase the likelihood that a core will disintegrate during a winding process. Therefore, it is desirable to provide cores that do not have defects. It has surprising been found that embodiments of a core comprising a lamination of paper and a laser-cut structure, such as at least one selected from a laser-cut notch and a laser-cut slot, can provide superior structural characteristics when compared an otherwise identical core including structures, such as notches and slots, that were cut using a punch and die. A core comprising laser-cut structures, such as slots or notches, can be free of defects such as roughly cut edges, edge crush defects, pressure-ring defects, and delamination that can be found in paper cores including notches or slots that were cut using a punch and die.

Generally, a core for winding yarn can comprise an oblong hollow body and a laser-cut structure, such as at least one selected from a laser-cut notch and a laser-cut slot, disposed through a portion of a wall of the hollow body. Laser-cut structures, such as notches and slots, are preferably formed adjacent to an end of the hollow body. In some aspects, an end of a hollow body can define an opening to an interior of the hollow body, so that a laser-cut notch or slot is contiguous with the opening. Embodiments of a core comprising both a laser-cut notch and a laser-cut slot include a structure where the notch is contiguous with an opening at the end of the hollow body, and the slot is contiguous with the notch and the opening. In preferred embodiments, a hollow body comprises a lamination of paper.

A method of cutting a core for winding yarn can comprise providing a core comprising an oblong hollow body, and irradiating a wall of the hollow body with a laser beam, while moving at least one of the hollow body and the laser beam, to form a laser-cut structure, such as at least one selected from a notch and a slot, at a position adjacent to an opening to an interior of the hollow body. In some aspects, a laser beam can be moved by a mirror galvanometer or by moving a laser beam emitting device. Some embodiments of a method of cutting a core comprise moving a laser beam with a mirror galvanometer and moving a hollow body relative to laser beam.

A method of winding yarn can comprise placing a core comprising a laser-cut structure, such as at least one selected from a laser-cut notch and a laser-cut slot, on a winding mandrel, placing a tail of a length of yarn through the notch or slot, and spinning the core to wind the length of yarn around the core. A bobbin can comprise yarn wound around a core comprising a laser-cut structure, such as at least one selected from a laser-cut notch and a laser-cut slot.

### BRIEF DESCRIPTION OF THE DRAWINGS

FIG. 1 illustrates a front view of a top of a core including portions cut with a punch and die;

FIG. 2 illustrates perspective view of a top end of the core illustrated in FIG. 1;

FIG. 3 illustrates an interior view of the top of the core illustrated in FIG. 1;

FIG. 4 illustrates a front view of a top of a core including portions cut with a punch and die;

FIG. 5 illustrates perspective view of a top end of the core illustrated in FIG. 4;

FIG. 6 illustrates a front elevational view of an embodiment of a core including laser-cut structures;

FIG. 7 illustrates a front view of a top of the core illustrated in FIG. 6;

FIG. 8 illustrates an interior view of the top of the core illustrated in FIG. 6;

FIGS. 9a-9c illustrate embodiments of a method and an apparatus for winding yarn around a core;

FIG. 10 illustrates an embodiment of a bobbin including yarn wound around the core illustrated in FIGS. 6-8; and

FIGS. 11 and 12 illustrate embodiments of a method and an apparatus for cutting a core.

### DETAILED DESCRIPTION

Yarn can be wound onto a core using a high-speed winder. A first stage of winding yarn on a core can include placing a length of yarn called a “tail” in a structure, such as notch or slot, formed into a wall at an end of the core. A notch or slot can hold the yarn as the winding process starts.

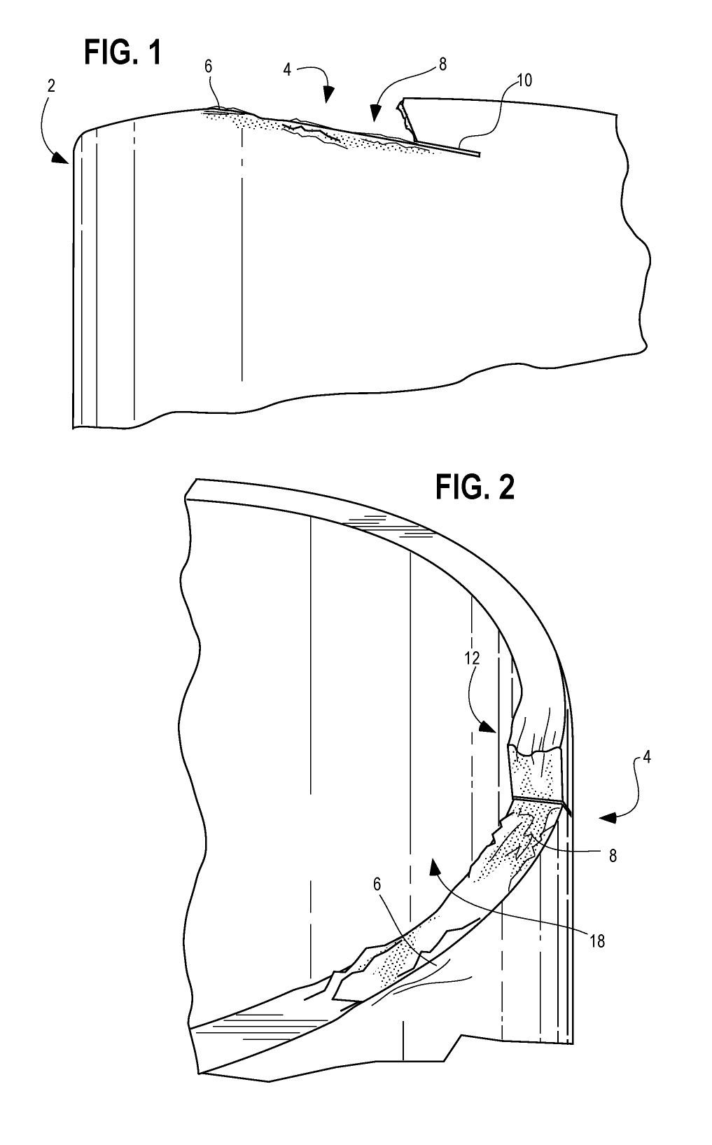

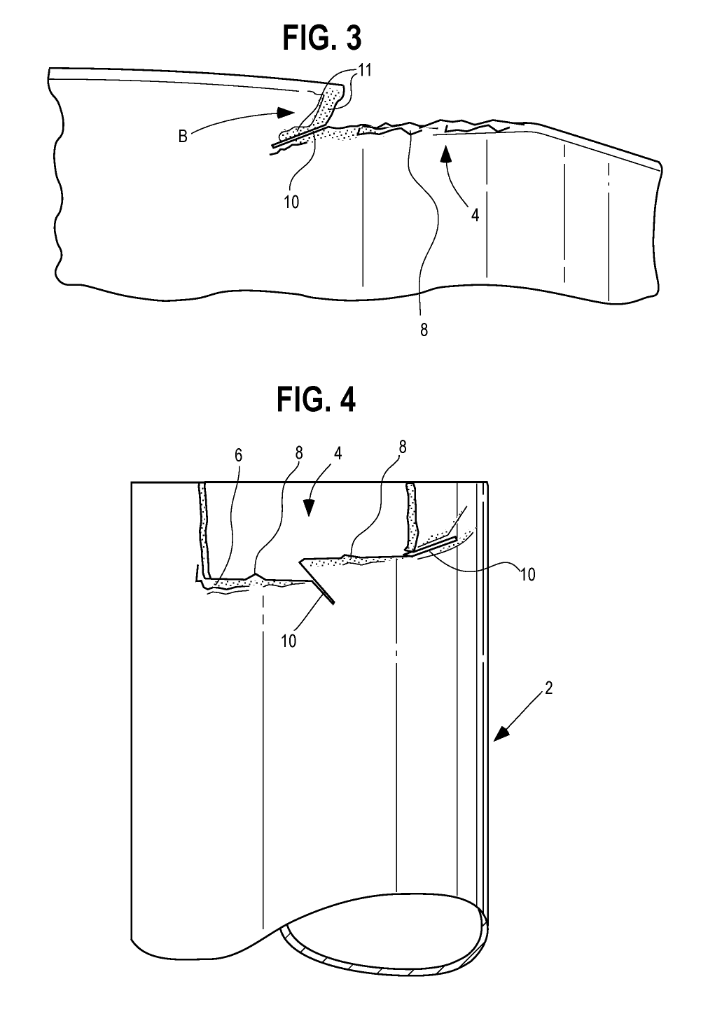

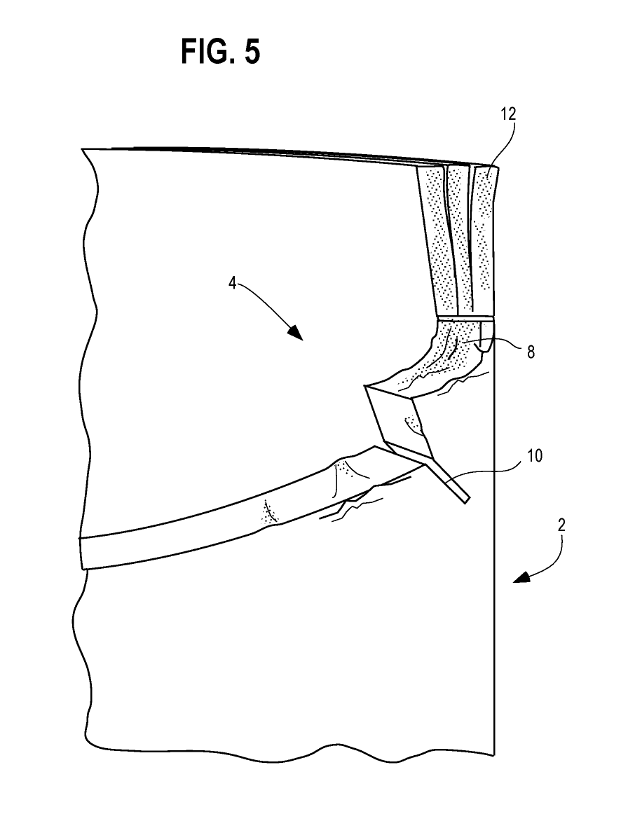

When a punch and die is used to cut notches and slots into paper cores, the punch or die must be frequently re-sharpened. This re-sharpening can generally decrease the rate of cutting and production of finished cores. Cutting paper cores with a punch and die can also create defects in a core. For example, the cores 2 illustrated in FIGS. 1-5 include notches 4 and slots 10 that were cut with a punch and die. FIGS. 2 and 3 illustrate different views of the core illustrated in FIG. 1, and FIG. 5 illustrates a different view of the core illustrated in FIG. 4. FIGS. 1-5 illustrate roughly cut edges 8 including fragments of torn paper, which were formed by insufficient cutting with a punch and die. Roughly cut edges can make it difficult to seat of a tail of yarn in a notch or slot. FIGS. 1 and 4 illustrate edge crush defects 6 adjacent to the cuts. Edge crush defects can be formed in a wall of a core by pressure applied from a punch and die. Roughly cut edges and edge crush defects can also cause a core to lose structural integrity. FIG. 3 illustrates pressure-ring 11 defects. Pressure-ring defects include protrusions of crushed paper on the backside of a cut formed by a punch and die. These protrusions of crushed paper can be caused by pressure from a punch and die and can prevent a core from properly fitting on a winding spindle or mandrel during a winding process. FIG. 3 also illustrates a tear-out defect 13 caused by the pressure and insufficient cutting caused by the punch and die. FIGS. 2 and 5 illustrate delaminated 12 layers of paper that were caused by insufficient cutting and pressure from the punch and die. These defects can increase the likelihood that a core will disintegrate under stress imparted by high-speed yarn winding.

Therefore, it is desirable for a core comprising structures, such as notches and slots, to be free of defects, to improve the structural integrity of a core, to increase efficiency of yarn winding processes, and to increase manufacturing profits.

A core for winding yarn made in accordance with the present disclosure can comprise an oblong hollow body. An oblong hollow body can generally comprise any configuration or any dimensions that are useful for winding yarn on, storing yarn on, or dispensing yarn from the hollow body, as well as those suitable for machinery that winds yarn, dispenses yarn, etc. An end of the hollow body can define an opening to an interior of the hollow body. One or both ends of the hollow body can define openings. In exemplary embodiments, both ends of a hollow body define openings. In some aspects, the oblong hollow body can comprise a tubular or a hollow frustoconical configuration. Similarly, the oblong hollow body and an opening of the hollow body can comprise any general cross-sectional configuration that is useful for winding yarn around the core. For example, a cross-section of an oblong hollow body or an opening of a hollow body can comprise a circular, ovate, square, rectangular, or polygonal configuration. A cross-section of an oblong hollow body and a cross-section of an opening of the hollow body can have the same or different configurations.

An oblong hollow body can have any length, such as a length ranging from 8 to 15 inches, 10 to 13 inches, or 11 to 12 inches. In an embodiment, a hollow body comprises a length of 11.4 inches. An oblong hollow body can have any internal diameter, such as any internal diameter ranging from 1 to 5 inches, 2 to 4 inches, or 2.5 to 3 inches. In an embodiment, a hollow body comprises an internal diameter of 2.875 inches. A hollow body can comprise any outer diameter, such as any outer diameter ranging from 1.2 to 5.2 inches, 2.2 to 4.2 inches, 2.7 to 3.2 inches, or 3.075 to 3.175 inches. A hollow body can comprise any wall thickness, such as any wall thickness ranging from 0.08 to 0.35 inches, 0.100 to 0.150 inches, or 0.200 to 0.300 inches.

The oblong hollow body of a core can be constructed of any material that is suitable for winding yarn around the core, shipping and storing yarn, and dispensing yarn from the core during textile manufacturing processes. In some aspects, an oblong hollow body can comprise at least one selected from a fibrous material, a metal, a polymer, and a resinous material. A hollow body can comprise a combination of these materials in the form of a composite. In exemplary embodiments, an oblong hollow body comprises a lamination of paper. A lamination of paper comprises a resinous material or adhesive holding the layers of paper together. An exemplary embodiment of a hollow body comprises a lamination of six layers of paper.

Any suitable laser-cut structure or configuration can be formed in a core in accordance with the present disclosure. Exemplary laser-cut structures include configurations and dimensions suitable for retaining a tail of yarn, winding yarn around a core, dispensing yarn from a core, etc., as well as those suitable for machinery that winds yarn, dispenses yarn, etc. An embodiment of a core comprising a hollow body including a lamination of paper can generally include laser-cut structures, such at least one selected from a notch and a slot, that are free of defects such as edge crush, roughly cut edges, pressure-ring defects, and delamination. In some embodiments, a laser-cut notch generally comprises any opening width at a position closest to an opening at an end of a hollow body. Exemplary opening widths of a laser-cut notch range from 1 to 2.5 inches, 1.25 to 2.25 inches, or 1.3 to 2 inches. Embodiments of a laser-cut notch generally comprise any internal width at a point spaced a distance from an opening at an end of a hollow body. An internal width of a laser-cut notch can be wider or narrower than an opening width of the notch. Exemplary internal widths of a laser-cut notch range from 1.2 to 2.7 inches, 1.45 to 2.45 inches, or 1.5 to 2.2 inches. A laser-cut slot can generally comprise any width and length. Exemplary widths of a laser-cut slot range from 0.005 to 0.015 inches, 0.008 to 0.012 inches, or 0.009 to 0.011. In an embodiment, a laser-cut slot has a width of 0.01 inches. Exemplary lengths of a laser-cut slot range from 0.1 to 0.7 inches, 0.15 to 0.6 inches, or 0.2 to 0.5 inches.

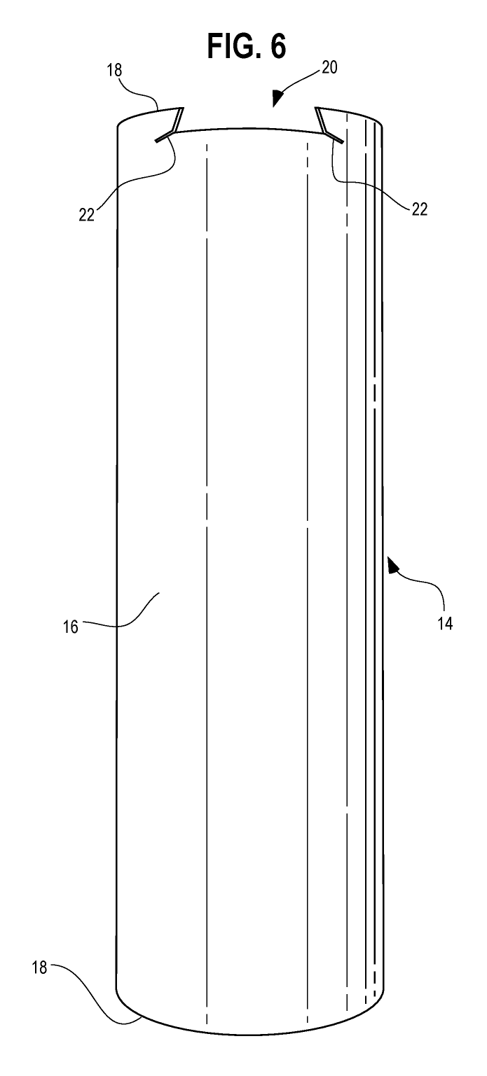

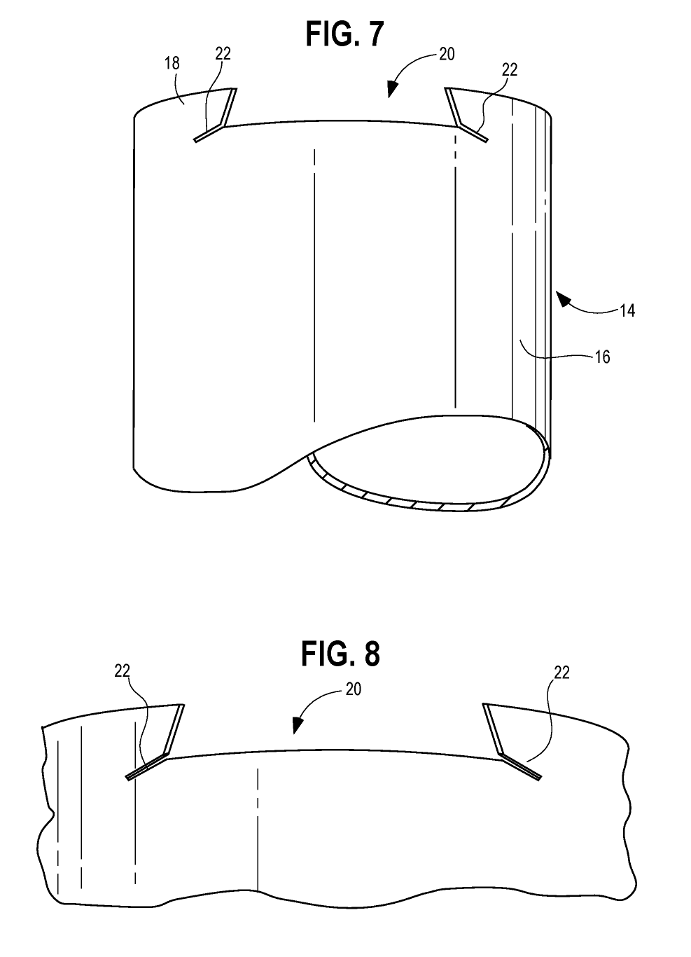

In some embodiments, notches and slots are cut with a laser in the configurations illustrated in FIGS. 1-5, but without the defects illustrated in FIGS. 1-5. In some embodiments, notches and slots are cut with a laser in the configurations illustrated in FIGS. 6-12, again without defects illustrated in FIGS. 1-5.

In some aspects, a core can comprise one or more a laser-cut notches disposed through one or more portions of a wall adjacent to the end of the hollow body, so that the notches are contiguous with the opening to the interior of the hollow body. In some embodiments, a laser-cut notch generally comprises a gap where a portion of a wall of a hollow body adjacent to the opening to the interior of the hollow body has been removed. A laser-cut notch can generally comprise any configuration that is useful for holding a tail of yarn when winding the yarn around the core.

In some aspects, a core can comprise one or more laser-cut slots disposed through one or more portions of a wall adjacent to the end of the hollow body, so that the slots are contiguous with an opening to an interior of the hollow body. A slot can generally comprise a narrow aperture or slit formed through a wall of a hollow body. A laser-cut slot can generally comprise any configuration that is useful for holding a tail of yarn when winding the yarn around the core. In some aspects, one or more slots can be cut through portions of a wall of a core adjacent to an opening at an end of a hollow body, so that ends of the slots extend away from the opening or a notch contiguous with the opening.

In some aspects, a core can comprise one or more notches and one or more slots. In other aspects, a core can comprise one or more notches and no slots. In yet other aspects, a core can comprise one or more slots and no notches. In some embodiments, a notch is formed through a portion of a wall of a core adjacent to an opening of the hollow body, one or more slots are formed through portions of the wall adjacent to the notch, the slots extend away from the notch, the slots are contiguous with the notch, and the slots and notch are contiguous with the opening.

FIGS. 6, 7, and 8 illustrate views of an exemplary embodiment of a core 14 for winding yarn. The core comprises an oblong hollow body 16 and openings 18 at opposite ends of the body. In this embodiment, the hollow body comprises a cylindrical and tubular configuration having a substantially uniform circular cross-section throughout the body and at the openings. The hollow body 16 comprises a lamination of paper. A laser-cut notch 20 and two laser-cut slots 22 are formed through portions of the wall of the hollow body adjacent to one of the ends of the body. The notch 20 and the slots 22 are contiguous with each other and the opening 18. The ends of the slots extend away from the notch. The core illustrated in FIGS. 6-8 is notably free of roughly cut edges, edge crush defects, pressure-ring defects, and delamination that are illustrated in FIGS. 1-5. The opening width of the embodiment of the notch illustrated in FIGS. 6-8 is 1.5 inches. The internal width of the notch in FIGS. 6-8 is 1.625 inches, between the openings of the two slots. A distance between the ends of the two slots in FIGS. 6-8 is 2.125 inches. The length of the slots in FIG. 6-8 is 0.25 inches, and the width of the slots in FIGS. 6-8 is 0.015 inches.

Any suitable method can be used for winding yarn around a core. In some aspects, a method of winding yarn can comprise placing a core on a winding mandrel, placing a tail of a length of yarn through a notch or a slot that has been laser-cut in the core, and spinning the core to wind the length of yarn around the core. Yarn can also be wound around a core without spinning the core, using any suitable process and machinery. Yarn can be wound around a core to form a bobbin. In some aspects, a bobbin can comprise a length of yarn that is wound around a core. A core of the bobbin preferably includes laser-cut structures, such as at least one of a notch and a slot. In some aspects, a tail of yarn can be disposed through a laser-cut notch or slot of a bobbin. In some textile manufacturing processes, a tail of yarn on a first bobbin can be connected to yarn from a second bobbin. This allows yarn to be pulled from the second bobbin by the tail of yarn on the first bobbin when all the yarn has been drawn off the first bobbin. A bobbin can be used in any suitable textile manufacturing process. For example, a bobbin including a core comprising a laser-cut structure such as at least one selected from a laser-cut notch and a laser-cut slot can be used in a process of making carpet by placing the bobbin on a creel and drawing yarn from the bobbin.

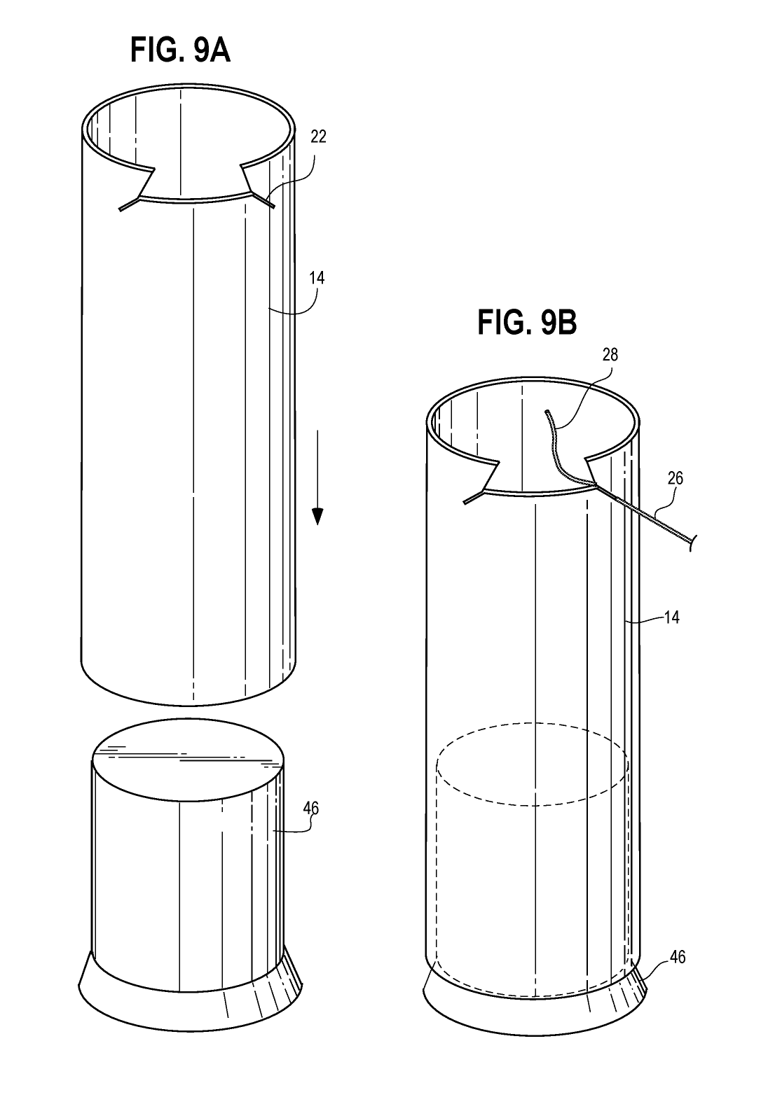

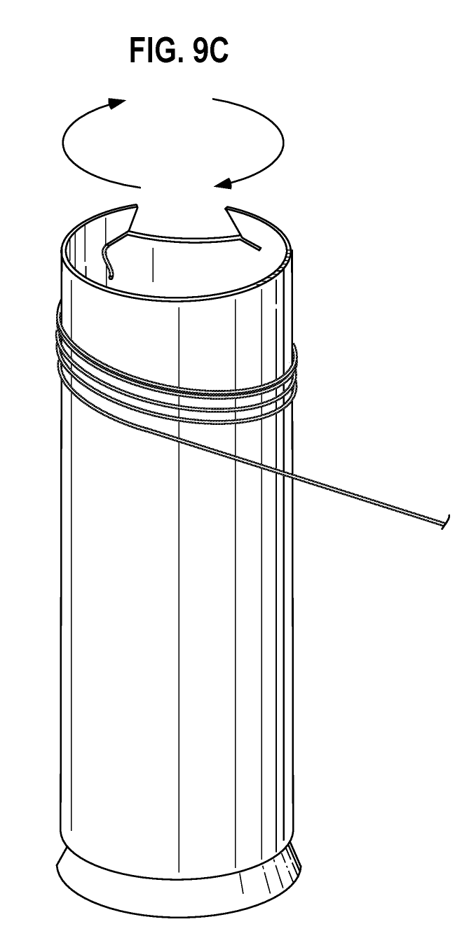

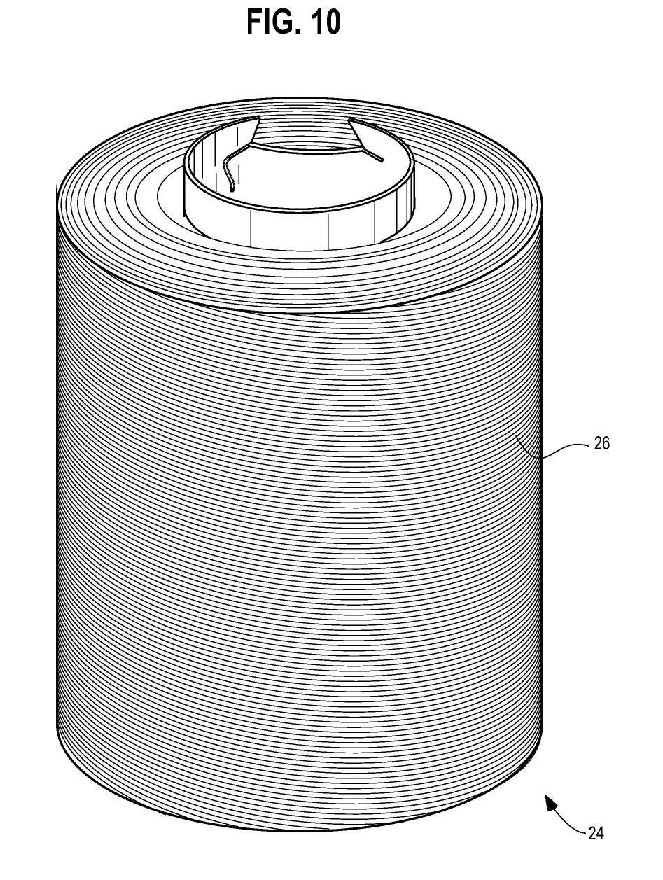

FIGS. 9a-9c illustrate embodiments of a method and apparatus for winding yarn around the core illustrated in FIGS. 6-8. In FIG. 9a the core 14 is being placed on a winding mandrel 46. FIG. 9b illustrates a tail 28 of yarn 26, after the tail has been placed through a laser-cut slot 22. FIG. 9c illustrates a condition where the core is being spun by the mandrel to wind a length of yarn around the core. FIG. 10 illustrates an embodiment of a bobbin 24 comprising yarn 26 wound around the core 14 illustrated in FIGS. 6, 7, and 8. In FIG. 10, a tail 28 of the yarn is disposed through one of slots 22 of the core.

A method of cutting a core can generally comprise providing a core comprising an oblong hollow body and irradiating a wall of the hollow body with a laser beam. An end of the hollow body can include an opening to an interior of the hollow body. The method can further comprise irradiating a wall of the hollow body with a laser beam to form a laser-cut structure, such as at least one selected from a notch and a slot, at a position adjacent to the opening. In an embodiment, the method of cutting a core comprises continuously and sequentially cutting a series of cores.

A 250 watt Diamond J-series CO₂ laser (sold by Coherent Inc.) is an exemplary laser beam emitting device that is useful generating a laser beam to irradiate and form laser-cut structures, such as at least one selected from a notch and a slot, in a wall of hollow body comprising a lamination of paper.

An embodiment of laser-cutting a notch comprises irradiating an outline of outer boundaries of the notch onto the wall of a hollow body using a laser beam, and removing the portion of the wall within the outer boundaries of the notch cut by the laser beam. An embodiment of laser-cutting a slot comprises irradiating a line of the slot onto the wall of a hollow body using a laser beam. In some embodiments, a specified width of a slot is greater than the width of a cut formed by a single pass of a laser beam across the wall of a hollow body. In these embodiments, a method of forming a slot comprises irradiating multiple adjacent and otherwise parallel lines with a laser beam to form the slot comprising the specified width. Generally, any portion of a core that is cut using a laser beam can comprise any of straight-line cuts and arcuate cuts.

A method of cutting a core can comprise moving at least one of a hollow body or a laser beam to form at least one laser-cut structure in the hollow body in at least one position adjacent to the opening at an end of the hollow body. Any suitable laser beam positioning device can be used to direct a laser beam to irradiate and cut portions of a hollow body and cut structures such as at least one selected from a notch or a slot. Exemplary laser beam positioning devices include mirror galvanometers, positioning motors attached to a laser beam emitting device, etc. A dynAXIS 3 galvanometer scanner (sold by SCANLAB GmbH) is an exemplary mirror galvanometer that is useful for moving a laser beam to irradiate a hollow body of a core comprising a lamination of paper. Any suitable conveying apparatus, such as at least one selected from a conveyor belt, a gantry, chute, etc. can be used to move a hollow body relative to a laser beam. A gantry can generally comprise a cross-member suspended or supported over a cutting area by any suitable supporting structure, such as pedestals or a scaffold. At least one selected from a laser beam emitting device or a laser beam positioning device can be attached to a cross-member of a gantry. A controller can be used to control a method of cutting a core. A controller can include a computer that is programmed to control and communicate with at least one selected from a conveying apparatus, a laser beam emitting device, laser beam positioning device, etc.

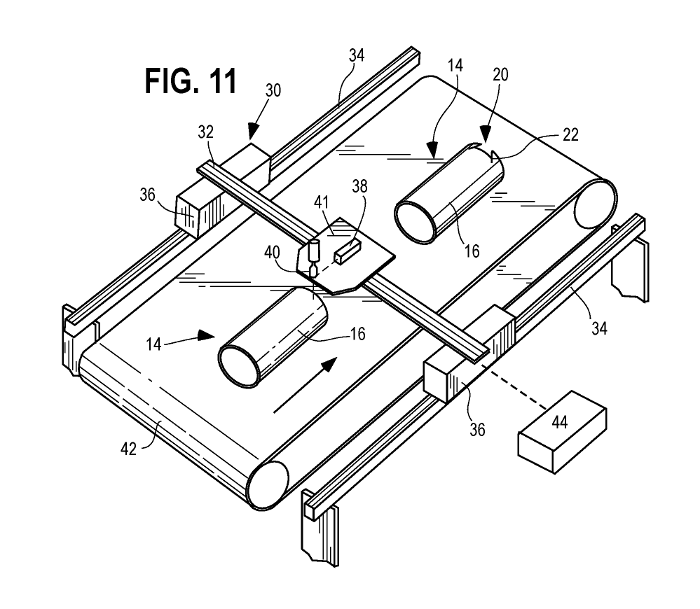

FIG. 11 illustrates an embodiment of a laser-cutting apparatus comprising a gantry 30 including a cross-member 32 and rails 34. Pedestals 36 are attached to the rails and support the cross-member. The pedestals include motors for moving the cross-member in either direction along the rails. A laser beam emitting device 38 emits a laser beam toward a mirror of a mirror galvanometer 40. The mirror galvanometer and laser beam emitting device are mounted on a platform 41. The platform can be moved across a track on the cross-member by motors, to aid in the positioning of the laser beam over a cutting area. The mirror galvanometer redirects and moves the laser beam across portions of a hollow body 16 of a core 14. The core rests on a conveyor belt 42 positioned between the rails 34 and below the cross-member 32. The conveyor belt can include grooves or other structures for retaining cores in a location to be irradiated by a laser beam. The conveyor belt 42 moves the core past the laser beam as the mirror galvanometer moves the laser beam across portions of the hollow body to cut a notch 20 and a slot 22 through a wall of the core. After the notch and slot are cut, the conveyor belt moves the core away from the laser beam. In this embodiment, a controller 44 includes a computer programmed to communicate with and control the operation of the gantry, the laser emitting device, the mirror galvanometer, and the conveyor belt.

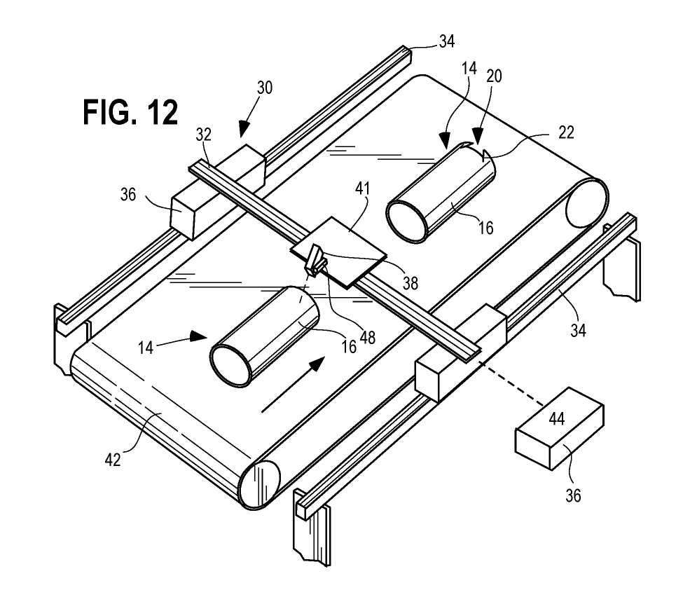

The embodiment of the gantry 30 illustrated in FIG. 12 is configured in the same manner as illustrated in FIG. 11, except the mirror galvanometer is omitted and a motor 48 moves the laser emitting device 38 to direct the laser beam to portions of the hollow body of the core.

A length of tubing can also be cut into sections using a laser beam emitting device. The sections can serve as oblong hollow bodies of cores. A method of forming an oblong hollow body can comprise cutting a length of tubing into sections by irradiating the tubing with a laser beam in a direction substantially orthogonal to a longitudinal axis of the tubing. The laser cutting can divide the tubing into at least two sections, and at least one of the sections can serve as an oblong hollow body of a core. A method of forming an oblong hollow body can comprise irradiating a length of tubing in a plurality of locations to divide the tubing into a plurality of sections.

In accordance with the present disclosure, a core for winding yarn can be free of defects such as roughly cut edges, edge crush defects, pressure-ring defects, and delamination. A core formed according to the present disclosure can provide improved manufacturing efficiencies by reducing the number of cores that disintegrate during high-speed winding of yarn and by increasing the ease in which a tail of yarn can be placed in a laser-cut structure on the core.

All methods described herein can be performed in any suitable order unless otherwise indicated herein or otherwise clearly contradicted by context. The use of any and all examples, or language describing an example (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

What is claimed is:

1. A core for winding yarn, the core comprising:
an oblong hollow body, an end of the hollow body defining an opening to an interior of the hollow body; and
a laser-cut notch disposed through a portion of a wall of the hollow body adjacent to the end of the hollow body, the notch being contiguous with the opening.

2. The core according to claim 1, further comprising a laser-cut slot disposed through the wall of the hollow body, the slot being contiguous with the notch and the opening.

3. The core according to claim 1, further comprising two laser-cut slots disposed through separate portions of the wall adjacent to the end of the hollow body, and the slots being contiguous with the notch and the opening.

4. The core according to claim 1, wherein the oblong hollow body has a tubular or a hollow frustoconical configuration.

5. The core according to claim 1, wherein a cross-section of the oblong hollow body comprises a circular, ovate, square, rectangular, or polygonal configuration.

6. The core according to claim 5, where a cross-section of the opening comprises a circular, ovate, square, rectangular, or polygonal configuration.

7. The core according to claim 1, wherein the oblong hollow body comprises at least one selected from a fibrous material, a metal, a polymer, and a resinous material.

8. The core according to claim 1, wherein the oblong hollow body comprises a lamination of paper.

9. The core according to claim 1, wherein opposite ends of the oblong hollow body define openings, and the laser-cut notch is disposed through the portion the wall of the hollow body adjacent to one of the opposite ends of the hollow body.

10. A bobbin comprising yarn wound around the core according to claim 1, a tail of the yarn being disposed through the laser-cut notch.

11. A method of cutting a core for winding yarn, the method comprising:
providing a core comprising an oblong hollow body, an end of the hollow body including an opening to an interior of the hollow body; and
irradiating a wall of the hollow body with a laser beam, while moving at least one of the hollow body and the laser beam, to form a laser-cut structure at a position adjacent to the opening.

12. The method according to claim 11, wherein the laser beam is moved by a mirror galvanometer.

13. The method according to claim 11, wherein the laser beam is moved by a mirror galvanometer and the hollow body is moved relative to laser beam.

14. The method according to claim 11, wherein the laser beam is moved by moving a laser beam emitting device emitting the laser beam.

15. The method according to claim 11, wherein the laser-cut structure comprises a notch contiguous with the opening.

16. The method according to claim 15, wherein the laser-cut structure further comprises a slot contiguous with the notch and the opening.

17. The method according to claim 15, wherein the laser-cut structure further comprises two slots contiguous with the notch and the opening.

18. A method of winding yarn, the method comprising:
placing a core on a winding mandrel, the core comprising:
an oblong hollow body, an end of the hollow body defining an opening to an interior of the hollow body; and
a laser-cut notch disposed through a portion of a wall of the hollow body adjacent to the end of the hollow body, the notch being contiguous with the opening;
placing a tail of a length of yarn through the notch; and
spinning the core to wind the length of yarn around the core.

19. The method according to claim 18, the core further comprising a laser-cut slot disposed through the wall of the hollow body, the slot being contiguous with the notch and the opening, the method further comprising placing the tail of the yarn through the slot.

20. The method according to claim 18, the core further comprising two laser-cut slots disposed through separate portions of the wall of the hollow body, the slots being contiguous with the notch and the opening, the method further comprising placing the tail of the yarn through at least one of the slots.
